(19) United States
(12) Patent Application Publication
(10) Pub. No.: US 2013/0339411 A1
(43) Pub. Date: Dec. 19, 2013

(54) Storage of Arbitrary Points in N-Space and Retrieval of Subset Thereof Based on Criteria Including Maximum Distance to an Arbitrary Reference Point

(71) Applicant: Matthew Thomas Bogosian, Marina, CA (US)

(72) Inventor: Matthew Thomas Bogosian, Marina, CA (US)

(21) Appl. No.: 13/970,755

(22) Filed: Aug. 20, 2013

Related U.S. Application Data
(63) Continuation of application No. 13/046,740, filed on Mar. 12, 2011.
(60) Provisional application No. 61/313,733, filed on Mar. 13, 2010.

(51) Int. Cl. G06F 17/10

(52) U.S. Cl. CPC G06F 17/10
USPC 708/207

(57) ABSTRACT

Systems and methods pertaining to nearness calculations of points in n-space. Among the embodiments is associating points of interest with point records in a data store, and efficient retrieval of subsets of those point records which meet arbitrary criteria. Criteria can limit retrieval to neighbors of a reference point (i.e., point records associated with points of interest whose home cells that share at least one interface with another designated home cell. Computationally expensive, at-retrieval range calculations are avoided by performing complimentary calculations at-storage and saving them with related records. The invention is appropriate for use with data storage mechanisms which limit inequality or range operations, or for which such operations result in inefficiencies. When used to model neighboring points on a planetary surface in 3-space, the invention does not suffer from polar distortion (where spherical coordinate systems have difficulty).

### PRIORITY CLAIM

This application is a continuation of U.S. utility application Ser. No. 13/046,740 filed on Mar. 12, 2011, which claims priority to U.S. provisional application 61/313,733, filed Mar. 13, 2010. This application incorporates the disclosures of all applications mentioned in this paragraph by reference as if fully set forth herein.

### COPYRIGHT STATEMENT

All material in this document, including the figures, is subject to copyright protections under the laws of the United States and other countries. The owner has no objection to the reproduction of this document or its disclosure as it appears in official governmental records. All other rights are reserved.

### BACKGROUND ART

The present invention relates to the storage and retrieval of arbitrary points in n-space in and from a data store and methods for implementing and using such an invention. More specifically, the invention relates to the computationally efficient retrieval of a subset of points in a data store that are within a specified distance of an arbitrary reference point that is not known at the time of storage. In addition the invention allows for arbitrary data to be stored with each point in a data store, and allows retrieval criteria to be specified for that data as well.

Efficiently searching through large data sets remains an important part of displaying relevant and targeted content to consumers of that data. Consumers demand and expect such targeted content to be readily available.

The importance of geo location data has grown with its pervasiveness. An increasing number of today's mobile products can “know where they are” either via satellite or signal triangulation. Such features are rapidly becoming standard in today's consumer communication devices. These devices are becoming more sophisticated in their abilities to produce content (e.g., images, video) as well as display it. The number of consumers of those devices is increasing as well.

Encoded in much consumer-produced content is the geo location data of the device at the time the content was created. This geo location data can be used to identify the content with a location. For example, a digital photograph contains not only the image itself, but may also contain the date, time and location of creation.

The ability to store vast libraries of digital content currently exists. However, consumers demand increasingly complex views into that content. For example, a consumer with a mobile device may want to publish a photograph taken in a location. Another consumer may want to compare that photograph with other published photographs taken near that same location.

Despite the increasing sophistication of applications and services making use of this content, the ability to efficiently identify and retrieve such subsets is limited. Existing methods are computationally expensive and unsophisticated and are hence ill-equipped to meet the projected demand.

Accordingly, it would be desirable to have innovative mechanisms that allow for not only the storage and retrieval of such content, but that would also allow efficient retrieval of subsets based on criteria relevant to the location of that content and/or the consumer of that content.

### SUMMARY OF THE INVENTION

The present invention provides innovative mechanisms to allow the storage of arbitrary data associated with arbitrary points in n-space (primary points) and to allow the retrieval of subsets of that data matching arbitrary criteria which could include those whose associated points are within a specified distance of an arbitrary point unknown at the time of storage. The mechanisms provide for a predictable calculation to associate set(s) of points (secondary points) with each point. A set of secondary points may define a shape which encloses the primary point (e.g., triangle, square, hexagon, tetrahedron, cube, combinations thereof, etc.). Shapes could share vertices with neighboring shapes. The sets of points defining the vertices of these enclosing shapes may be referred to as “canonical sets” or sets of “canonical points”. If a canonical point is encoded as a single number, it may be referred to as a “canonical number”. Primary points which share one or more canonical points in a specific set are considered near each other (i.e., within the specified distance, or within the same or neighboring enclosing shape), whereas those which don't are not.

By allowing nearness comparisons to be based on intersection of common values, the mechanisms provide a vastly more efficient means of retrieval than traditional methods because comparisons are direct or equality-based rather than range- or inequality-based.

In one embodiment, the invention provides a method for a user to store points in n-space and related data where the set(s) of canonical points are computed automatically from the points stored. An administrative user defines a schema indicating what (if any) data is to be associated with each point, which could include required data, optional data, or could permit storage of arbitrary data not defined within the schema. The administrative user also defines the method of computing the canonical points to be associated with each point. When a storing user submits a point and associated data for storage, the data is verified against the schema, the canonical points are calculated from the submitted point (and optionally any associated data), and the point, submitted data and canonical points are all stored as a record (or set of associated records) in the data store.

In another embodiment, the invention provides a method for a user to specify criteria defining a subset of all stored points and to retrieve that subset of points and associated data. A retrieving user submits criteria specifying zero or more limits on the points' associated data along with zero or more arbitrary points that the retrieved points must be “near”. Canonical points are calculated for each arbitrary point using the same calculation as in the storage embodiment (above). Points in the data store that share one or more canonical points with those generated from the arbitrary points and which meet any other specified criteria are transmitted to the retrieving user along with any data associated with those points.

In another embodiment, the invention provides a method for storage and retrieval of points in 3-space which exist on the surface of a solid approximating a spherical object (like a planet). The spherical object is approximated by a non spherical surface made up of discrete faces (e.g., a Platonic solid or subdivision or tessellation thereof) as determined by an administrative user. During storage, the enclosing face on the solid is computed for the point submitted by a storing user. The canonical numbers stored with that point are computed as encoded representations of the vertices of that face. During retrieval, the same calculation is applied to any arbitrary point(s) submitted by a retrieving user. Points retrieved will share one or more vertices with any arbitrary point(s) submitted.

In another embodiment, the invention provides a method for storage and retrieval of points in n-space based on shapes whose edges are all equal in length (e.g., line segment, square, cube, hypercube, etc.), the magnitude of which is determined by an administrative user. During storage, the enclosing shape is computed for the point submitted by a storing user. The canonical numbers stored with that point are computed as encoded representations of the vertices of that shape. During retrieval, the same calculation is applied to any arbitrary point(s) submitted by a retrieving user. Points retrieved will share one or more vertices with any arbitrary point(s) submitted.

In another embodiment, the invention provides a method for storing an arbitrary number of canonical sets with each point. Each canonical set may represent a single distance and a single calculation model. Multiple canonical sets allows for multiple enclosing shapes (i.e., multiple distances [e.g., one set for 1 m, one for 10 m, 100 m, 1 km, etc.] and multiple calculation models) to be associated with each point in the data store simultaneously. The number and definitions of each canonical set to be stored with each point is defined by an administrative user. During storage, multiple enclosing shapes are computed for the point submitted by a storing user. Multiple sets of canonical points are stored with that point, each set corresponding to one enclosing shape. During retrieval, a retrieving user specifies which canonical set(s) should be used for comparison with any arbitrary point(s) submitted by the retrieving user. Points retrieved will share one or more vertices with the arbitrary point(s) submitted.

With the embodiments, any number of canonical sets may be stored with each point along with any other arbitrary data. This allows for the retrieval of “near” points within any distance specified by an administrative user. Multiple sets can exist simultaneously, so the same data store may be used to retrieve points within as many different distances as sets without significantly affecting efficiency. Additional sets may be computed and stored at any time, since they are based on data present in the data store. This would allow an administrative user to create a schema defining two sets (e.g., one representing 1 km, and one 100 km). Assuming storing users populated the data store with many points, an administrative user could later decide to add a third set (e.g., 10 km). The third set would be computed for each point in the data store and stored with that point. From then on points submitted by storing users would acquire all three sets, and retrieving users would be able to use the third set in their subset criteria.

### BRIEF DESCRIPTION OF THE DRAWINGS

FIG. 1 shows a block diagram of an embodiment within the context of a network.

FIG. 2. shows a block diagram of an embodiment of the storage of points in a data store.

FIG. 3 shows a block diagram of components that may be present in devices and computer systems that implement the invention.

FIG. 4 shows a flowchart of a process to retrieve points from the data store that match arbitrary criteria.

FIG. 5 shows a flowchart of a process to store new points in the data store.

FIG. 6 depicts points within a common face in two different models (note how one of the points nearest to p is excluded, while points several times farther away are included).

FIG. 7 depicts near points within neighboring faces in two different models (while not perfect, coverage will closer approximate a true radius with these models).

FIG. 8 depicts recursive intersection/subdivision of the 4th degree.

FIG. 9 [prior art] depicts dot product rule in/out optimization.

FIG. 10 [prior art] depicts barycentric coordinates as altitudes.

FIG. 11 depicts quantized barycentric altitude divisions.

FIG. 12 depicts quantized barycentric triangulation.

FIG. 13 depicts home faces, edges & vertices and near points.

FIG. 14 depicts a 2-space projection analogizing a tetrahedron-based model.

FIG. 15 depicts a visualization of cubic quantization (the green dot is the point of interest, the green cube is its home volume, the red dots and cubes are other points of significance and their respective home volumes, and the large gray cube contains points near to the point of interest).

FIG. 16 depicts a 2-space projection analogizing a home cube with a sphere of influence.

### DESCRIPTION OF THE EMBODIMENTS

In the description that follows, the present invention will be described in reference to embodiments that allow for the storage and retrieval of arbitrary points in n-space in and from a data store. More specifically, the embodiments will be described in reference to preferred embodiments. However, embodiments of the invention are not limited to any particular configuration, architecture, or specific implementation. Therefore, the description of the embodiments that follows is for purposes of illustration and not limitation.

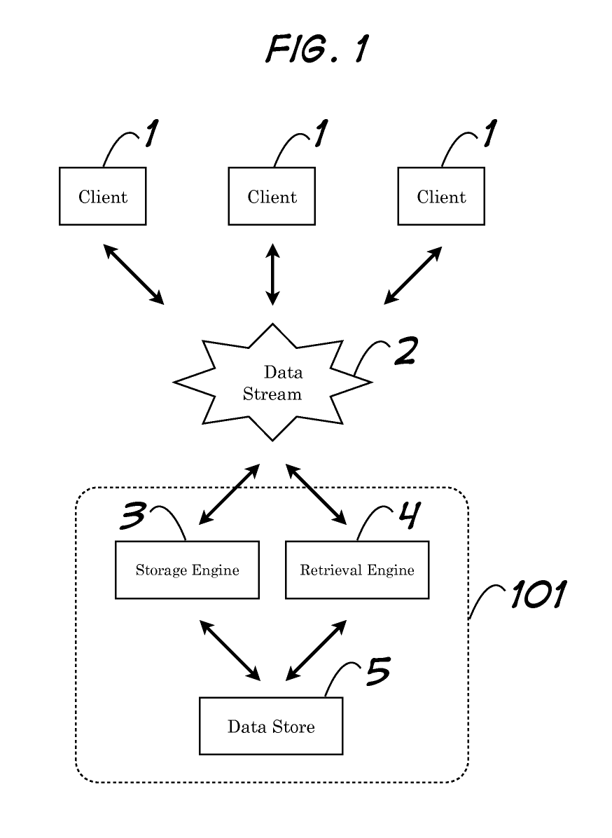

FIG. 1 shows a block diagram of an embodiment within the context of a network. Client 1 interacts through a data stream 2 with a server 101. The Data stream 2, like all network representations shown herein, can be any network media that allows network devices to communicate.

Server 101 consists of a storage engine 3 and a retrieval engine 4. Storage engine 3 and retrieval engine 4 may be independent components, or they may exist as part of a larger component (e.g., one that is exposed through a single Application Programmer's Interface [API]).

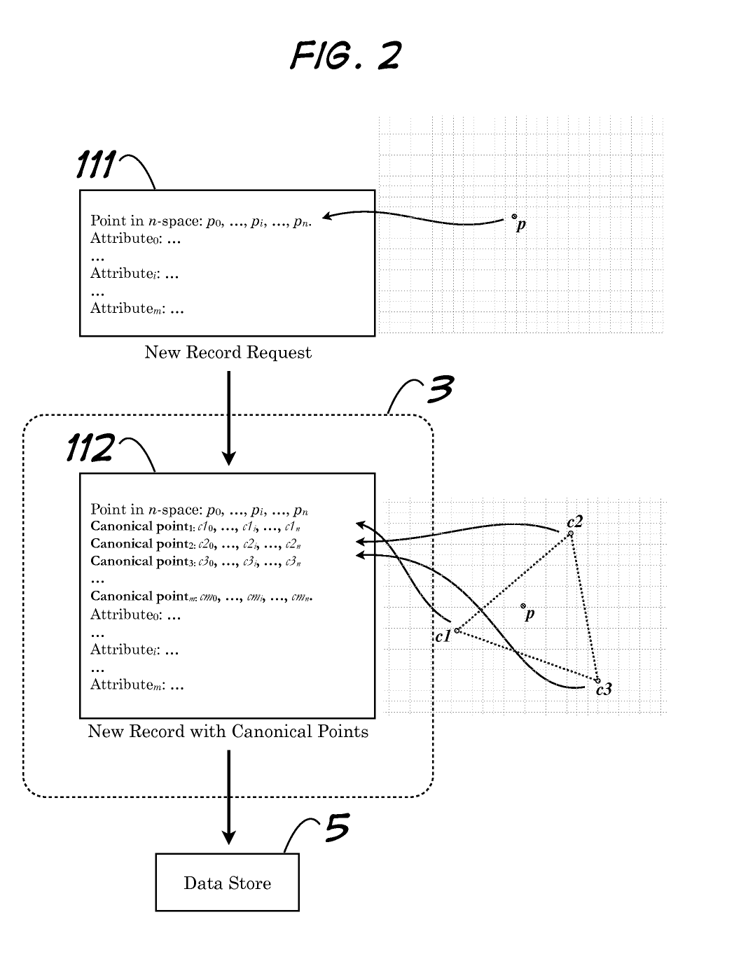

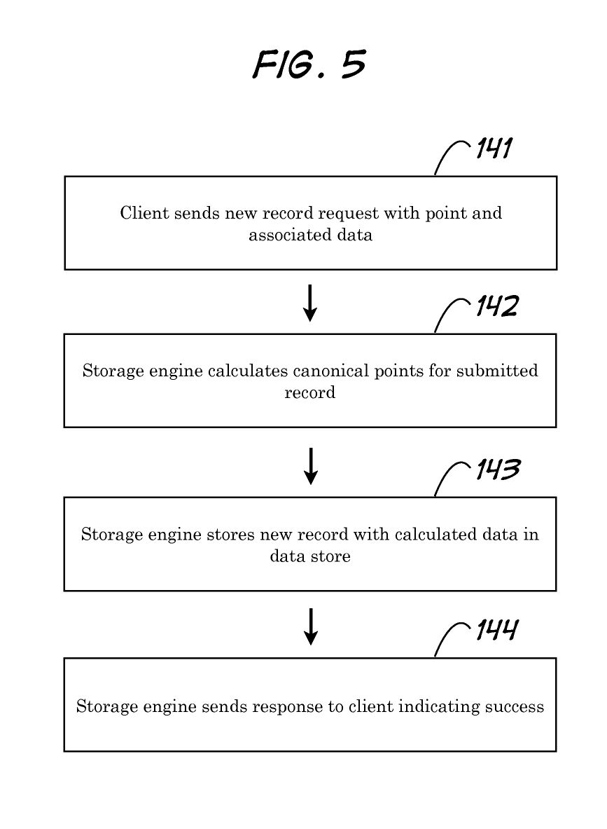

Storage engine 3 interacts with data store 5 to store an arbitrary set of points in n-space along with arbitrary data associated with each of those points as well as any calculated canonical points to be used by the retrieval engine. This process is illustrated in more detail in FIGS. 2 and 5.

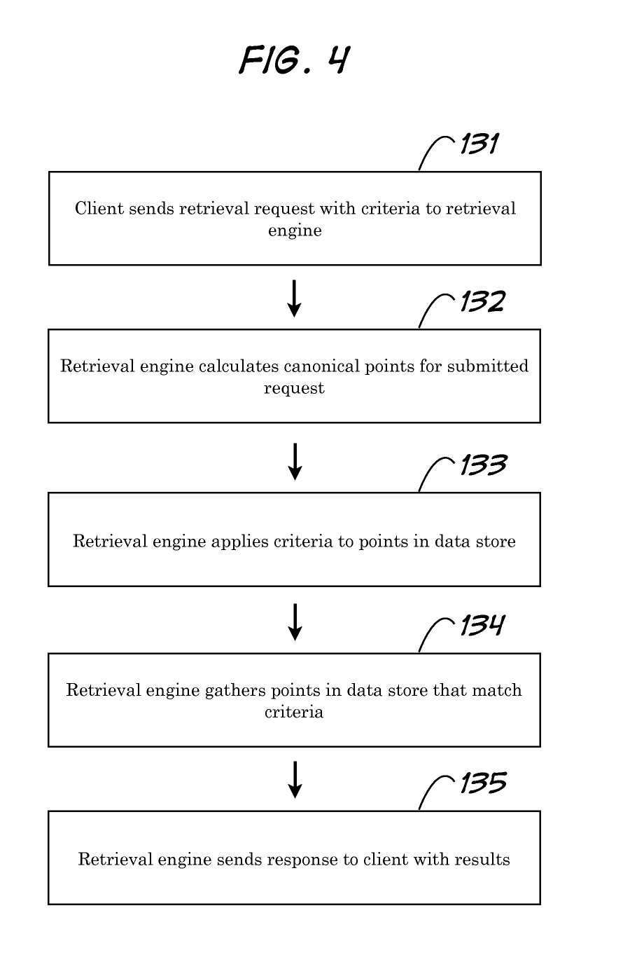

Retrieval engine 4 receives arbitrary matching criteria from client 1. Retrieval engine 4 interacts with data store 5 to perform queries which match points stored in data store 5 against the arbitrary criteria received from client 1. Retrieval engine 4 retrieves data associated with any matched points from data store 5 and sends the subset of matched points and corresponding data to client 1. This process is illustrated in more detail in FIG. 4.

FIG. 2. shows a block diagram of an embodiment of the storage of points in a data store. Client sends new record request 111 consisting of a point in n-space and any corresponding data to storage engine 3. Storage engine 3 calculates any canonical points associated with the point in n-space submitted as part of new record request 111. Storage engine 3 merges new record request in and the calculated canonical points into new record with canonical points 112. Storage engine 3 submits new record with canonical points 112 to data store 5 for storage and later retrieval. Retrieval is illustrated in more detail in FIG. 4.

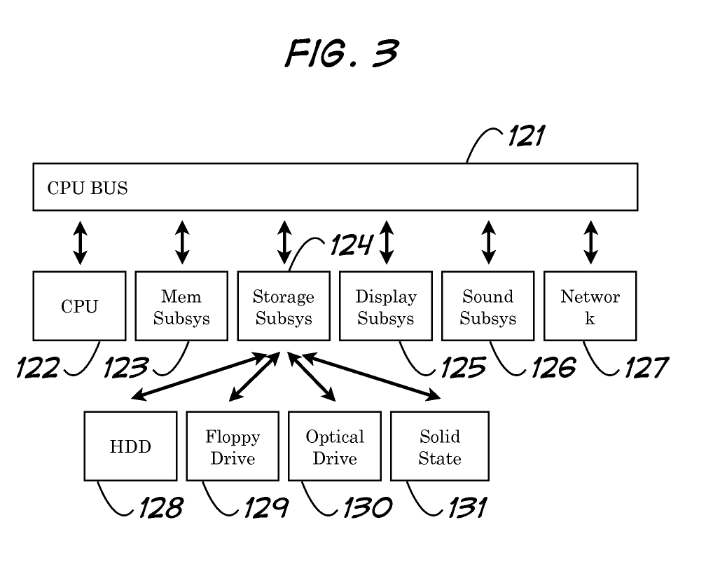

FIG. 3 shows a block diagram of components that may be present in devices and computer systems that implement the invention. Additional or fewer components may exist in any individual device. Nevertheless, FIG. 3 is fairly representative.

A central processing unit (CPU) bus 121 allows the various components of the computing device to communicate. A CPU 122 executes instructions or computer code which can be stored in a memory subsystem 123. Memory subsystem 123 represents what is typically volatile memory.

A display subsystem 125 is responsible for displaying information, images or text to users. A sound subsystem 126 is responsible for generating sound and may include one or more speakers. A network subsystem 127 allows that computing device or computer system to communicate over a network.

A storage subsystem 124 is responsible for nonvolatile storage of computer code and data. Representative storage media include a hard drive 128, a floppy drive 129, an optical (e.g., CD-, DVD-ROM, etc.) drive 130, or a solid state storage 131.

The storage and retrieval mechanisms can be accessible via to clients via a data stream like local shared memory, a proprietary network, or the Internet and can be made available using modern remote procedure call protocols (e.g., REST, SOAP, XML-RPC, proprietary protocols, etc.). Support for additional protocols can be added according to developer demand.

Moving from a description of representative hardware and interfaces, FIG. 4 shows a flowchart of a process to retrieve points from the data store that match arbitrary criteria. As with all flowcharts shown herein, steps can be added, deleted, combined, and reordered without departing from the spirit and scope of the invention.

At step 131, a request is made from the client to the retrieval engine. The request includes matching criteria. The matching criteria could include a point in n-space.

At step 132, the retrieval engine calculates the canonical points for any point(s) submitted with the matching criteria in step 131.

At step 133, the retrieval engine retrieves all points from the data store which match the criteria and share any canonical point with the canonical points calculated in step 132.

In alternate embodiments, more complex canonical point and other criteria matching may be described in the request by the client using boolean logic and other operators (e.g., comparative operators like ≦ and >, string matching operators like “begins-with” or “contains”). This is not an exhaustive list. It is merely illustrative of providing the ability to express complex queries using arbitrary expressions.

At step 134, the retrieval engine gathers all data associated with the zero-or-more points found in step 133.

At step 135, the list of points and corresponding data retrieved in steps 133 and 134 are sent to the client.

In alternative embodiments, clients may specify schema definitions along with matching criteria to narrow the amount of data retrieved in step 134 and returned in step 135 so that not all corresponding data is sent to the client. This could be in the form of a limit on the number of points returned, ordering specifications, or an inclusionary or exclusionary list of the types, names, etc. of any corresponding data to either return or omit.

FIG. 5 shows a flowchart of a process to store new points in the data store.

At step 141, a new record request is made from the client. The new record request contains an arbitrary point in n-space and an arbitrary set of data associated with that point.

At step 142, the storage engine calculates the canonical points for the point submitted as part of the new record request.

At step 143, the storage engine stores the new record submitted in step 141 along with the canonical points calculated in step 142 in the data store.

At step 144, the storage engine (optionally) sends a response to the client indicating to success.

### PRIOR APPLICATION

As mentioned above, this application claims priority to U.S. provisional application 61/313,713, filed Mar. 13, 2010. For convenience of the reader, key portions of U.S. provisional application 61/313,713 as filed on Mar. 13, 2010 are reproduced below.

### Are You Near Me?—Efficient Methods for Storage & Comparison of Geo Location Data

This disclosure presents and explores several algorithms that, given a latitude/longitude pair, efficiently retrieve points of significance “near” that location. The algorithms do not suffer from polar distortion (where spherical coordinate systems have difficulty) and can be used to query data in storage systems which limit inequality or range operations. Trigonometric computations are only performed during the translation of the initial latitude/longitude pair. Finally, this article will explore extending those algorithms to nearness determinations in arbitrary 3-space.

### BACKGROUND

Despite the continued momentum of Moore's assertion, the efficiency of calculations and data storage still remain relevant in today's world of computation. As the prevalence of computational capacity increases, problems of greater complexity are attempted which in turn demand additional capacity. Sometimes entire markets are discovered (see for example the cyclical race between special-purpose spatial calculation and rendering hardware and its use in video game consoles and film production).

Shared computation resources such as Amazon's Infrastructure Services or Google's App Engine are becoming more popular. With such services, resource-intensive computations can literally be quite expensive. Fees typically grow in proportion to the number of cycles consumed or amount of data stored per billing period. In addition, processes that exceed resources ceilings face termination. Designs allowing more complex computations within such limitations are often nontrivial. New algorithms that reduce (rather than divide and distribute) complexity require rare expertise.

The importance of geo location data has grown with its pervasiveness. Many of today's mobile products such as Apple's immensely popular iPhone or Motorola's Droid can “know where they are” either via satellite or signal triangulation. Such features are rapidly becoming standard in today's consumer communication devices.

### The Problem

Spherical coordinate systems may seem seductively obvious for ellipsoid planetary surfaces, but (as many have observed) the pitfalls are many:

The traditional angular measurements of latitude and longitude are extremely unsuitable for automated computations. Few, if any, spatial problems can avoid multiple evaluations of trigonometric functions.¹ 1Lukatela, Hrovje, “Hipparchus Geopositioning Model; an Overview,” Baltimore; AUTO-CARTO 8, March 1987, Web, 5 Jan. 2010.

Such systems do not lend themselves to accurate distance and area calculations:

Various schemes based on latitude/longitude “rectangles” are often used for large coverage or global databases. However, resulting cell network [sic] is hard to modify in size and density, high-latitude coverage can be restricted or inefficient, and in most cases the approach forces the use of unwieldy angular coordinates.² 2Lukatela 1987.

In other words, approximating nearness using a latitude range and a longitude range may be adequate near the equator, but the same approach becomes distorted and impractical as one approaches the poles.

In addition, while most modern relational database systems' indexing capabilities are sufficient for dealing with arbitrary ranges, not all data storage systems perform well (or at all) with such models. Berkeley DB, for example, requires maintaining such indexes manually. Google's App Engine does not allow selections on ranges of more than one variable.

Some have suggested using Morton numbers for latitude/longitude pairs (also known as Geohashes) to make coordinate range searches possible within such limitations.³ However, that approach does not allow for additional range variables. For example, designing a query to retrieve the five most recent reviews of restaurants within a given radius of a latitude/longitude pair would not be possible using such a model. 3Hitching, Bob. “Scalable, Fast, Accurate Geo Apps Using Google App Engine+Geohash+Faultline Correction.” Web blog post. Mobile Geo Social. 10 Nov. 2009, Web. 25 Jan. 2010.

### A Proposed Solution

One approach to avoiding at-retrieval range calculations is to perform those calculations at-storage and save them with related records. For nearness searches of arbitrary latitude/longitude pairs, this is non-trivial but possible with forethought as we will see below.

The first step is translating latitude/longitude pairs to a model that does not suffer from the aforementioned limitations of spherical coordinate systems. A general solution divides the surface or space of interest into (roughly) equal sized quanta or cells and then computes the quantum or cell which contains the point of interest. Other points that are contained by the same quantum (or neighboring quanta) are considered “near”.

### Convex Polyhedron Coordinate Models

A natural choice is a model based on Platonic solid with numerous vertices such as a dodecahedron or an icosahedron. More complex models based on Archimedean solids such as the truncated icosahedron or the snub dodecahedron are also possible.⁴ 4This is not a new area of study. Much effort has been made modeling planetary ellipsoid surfaces using polygons in order to increase accuracy and efficiency of geodetic calculations. [Citations omitted.] However, these efforts have been primarily directed toward high-accuracy representations of surface area and geometry.

These solids are appropriate starting points since they are highly regular and tend to approximate spheres nicely. Regularity is not necessarily required, but some degree of facial uniformity is desirable for reasons discussed below.

Conversion from latitude/longitude to a model solid coordinate system is relatively straightforward. Each of the model solid's faces are represented in a cartesian coordinate system. Its center is at the origin and its vertices lie on a sphere with a radius.

The latitude/longitude coordinate pair of interest is translated to a cartesian vector v using a standard spherical coordinate conversion. (See eq. 1.)

### Equation 1: Latitude/Longitude Coordinate Pair as a Cartesian Vector

$$\begin{matrix}φ = rad ( lon ) \\ θ = rad ( lat ) \\ v = [ \begin{matrix}x \\ y \\ z\end{matrix} ] = [ \begin{matrix}r cos ( θ ) cos ( φ ) \\ r cos ( θ ) sin ( φ ) \\ r sin ( θ )\end{matrix} ]\end{matrix}$$

Cartesian vectors are advantageous since there is no shortage of efficient intersection detection algorithms. While trigonometric functions are used for the initial conversion, no other trigonometric computations are necessary.

Each of the solid's faces are tested to find which intersect with v using whatever method is appropriate. The m unique intersecting face(s) are the “home” face(s) to the point of interest.

Different resolutions can require subdividing each face of the solid. For example, a dodecahedron may be subdivided into a pentakis dodecahedron. For reasons explored below, subdivisions that yield near-uniform triangles typically provide adequate accuracy with high efficiency. This means that most Catalan solids should be avoided. Icosahedral subdivisions are convenient.

### Representations (“Home Vertices”)

Each home face is a set of n unique vertices in 3-space. (See eq. 2.)

### Equation 2: Set of a Point's Home Faces in s-Space

$$f = \{ \begin{matrix}{v}_{{1}_{1}} & ⋯ & {v}_{{n}_{1}} \\ ⋮ & ⋱ & ⋮ \\ {v}_{{1}_{m}} & ⋯ & {v}_{{n}_{m}}\end{matrix} \} = \{ \begin{matrix}[ \begin{matrix}{x}_{{1}_{1}} \\ {y}_{{1}_{1}} \\ {z}_{{1}_{1}}\end{matrix} ] & ⋯ & [ \begin{matrix}{x}_{{n}_{1}} \\ {y}_{{n}_{1}} \\ {z}_{{n}_{1}}\end{matrix} ] \\ ⋮ & ⋱ & ⋮ \\ [ \begin{matrix}{x}_{{1}_{m}} \\ {y}_{{1}_{m}} \\ {z}_{{1}_{m}}\end{matrix} ] & ⋯ & [ \begin{matrix}{x}_{{n}_{m}} \\ {y}_{{n}_{m}} \\ {z}_{{n}_{m}}\end{matrix} ]\end{matrix} \}$$

n and m could have different values depending on the solid used in the model. For an icosahedron, n would always be 3, and m could be 1, 2 or 5 depending on whether the point of interest intersected with a face, an edge or a vertex, respectively. For a dodecahedron, n would always be 5, and m could be 1, 2 or 3. For a truncated icosahedron, n could be 5 or 6 and m could be 1, 2 or 3. For a bisection-subdivided icosahedron, n would still always be 3, but because of the subdivisions, if the point of interest intersected with a vertex, m could be 5 or 6 depending on which one. In practice however, m is almost always 1.

The cartesian coordinates of each home vertex j for each face i can be used to create a Morton number vⱼᵢ unique to that vertex. (See eq. 3.)

### Equation 3: home vertices in 3-space as Morton numbers

vⱼ_{ᵢ}=mort(xⱼ_{ᵢ},yⱼ_{ᵢ},zⱼ_{ᵢ})

home(v)={v₁_{ₗ}, . . . ,vⱼ_{ᵢ}, . . . ,vₙ_{ₘ}}

Each home vertex's Morton number vⱼᵢ is stored as an attribute of the point in the data store.

### “Nearness” within a Convex Polyhedron Coordinate Model

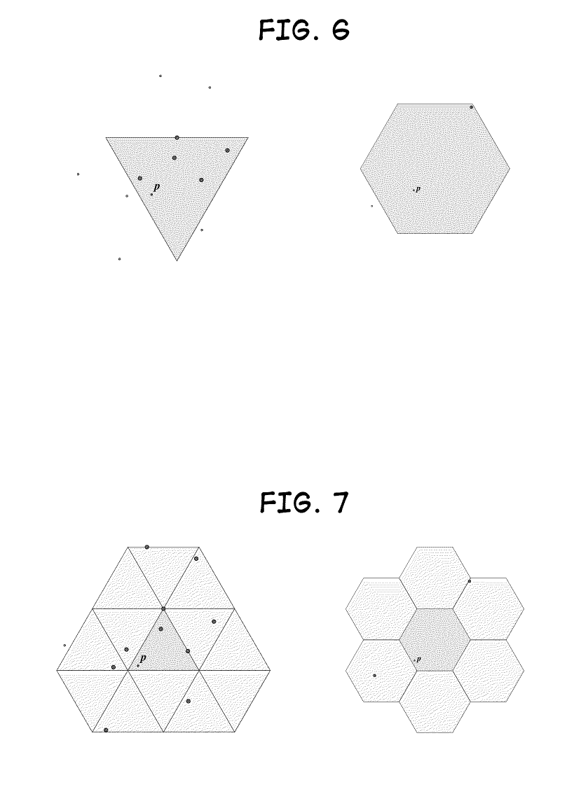

To determine wether two points are near each other, the most obvious approach is to test if any of the two points' home faces are the same. While this generally works where the point of interest is near the center of its home face, artifacts can occur if it lies near an edge. (See FIG. 6.)

An better approximation defines two points p and q as being “near” each other if and only if p and q share at least one home vertex. (See eq. 4, FIG. 7.)

### Equation 4: a Near Point

near(p,q) [symbol] home(p)∩home(q)≠

This does not completely avoid but does significantly reduce artifacts from near-edge points of interest. Those remaining can be discarded post-retrieval if necessary.

### Application

A very common scenario (examples of which have already been mentioned) asks, given a single point of interest p and a set of points of significance Q, what is the subset Q′ which are near top? (See eq. 5.)

### Equation 5: Subset of Near Points

Q′={q:qεQ,near(p,q)}

In Google's App Engine, this could be expressed in GQL. (See code list. 1.)

### Code Listing 1: GQL for Near Points

SELECT *

FROM Points

WHERE home_vertices IN p₁ₗ, . . . , pⱼᵢ, . . . , pₙₘ

Q consists of all entities in the Points model. Q′ consists of the entities which are returned by the above query. The home_vertices property contains the calculated-at-storage home vertices' Morton numbers for each entity in Q. p₁ₗ, . . . , pⱼᵢ, . . . , pₙₘ are the calculated-at-retrieval home vertices' Morton numbers for the point of interest p.⁵ Note, because the IN operator is treated as an equality operator in GQL, one could sort on another variable. (See code list. 2.) 5Technically, Morton numbers are not necessary in this implementation. Any mechanism that can translate between three scalars and a single bit array without ambiguity is sufficient. For example, fixed-width bit fields representing each dimension in a vertex could be concatenated rather than interleaved.

Code listing 2: GQL for near points ordering by another variable

SELECT *
FROM Points
WHERE home_vertices IN pₗ₁, ..., pⱼᵢ, ..., pₙₘ
ORDER BY updated_date DESC
LIMIT 200

Assuming all points were derived from a bisection-subdivided icosahedron where the degree of successive divisions was 6, the above query would retrieve the 200 most recently updated points within (roughly) a 100 km radius of p.

Nothing prevents storage of more than one set of home vertices per entity. For example, assuming radii of 1, 10 and 100 km are known in advance to be of interest, one could store each entity with three different properties: home_vertices_{—}1 km, home_vertices_{—}10 km and home_vertices_{—}100 km.⁶ Subsequent queries would be made against the appropriate property. 6For a bisection-subdivided icosahedron, these are roughly represented by degrees of successive subdivision 13, 10 and 6, respectively.

### Limitations & Optimizations

### Intersection and Subdivision

The number of faces required in the model solid is inversely proportionate to the radius precision. For example, for a bisection-subdivided icosahedron, the number of surface triangles is 20×4n where n is the number of successive subdivisions. A radius of roughly 10 km (a useful measurement in many modern applications) requires 10 subdivisions (or 20,971,520 surface triangles). A radius of 1 km requires 13 subdivisions (1,342,177,280 triangles). A radius of 100 m requires 16 subdivisions (85,899,345,920 triangles).

It is not practical to calculate and store the faces of such complex solids ahead of time. Even if it were, checking intersections with each sub face would likely take months or years. Most applications require access to multiple subdivisions. Therefore, a method calculating intersections at arbitrary subdivisions at run-time must be made available.

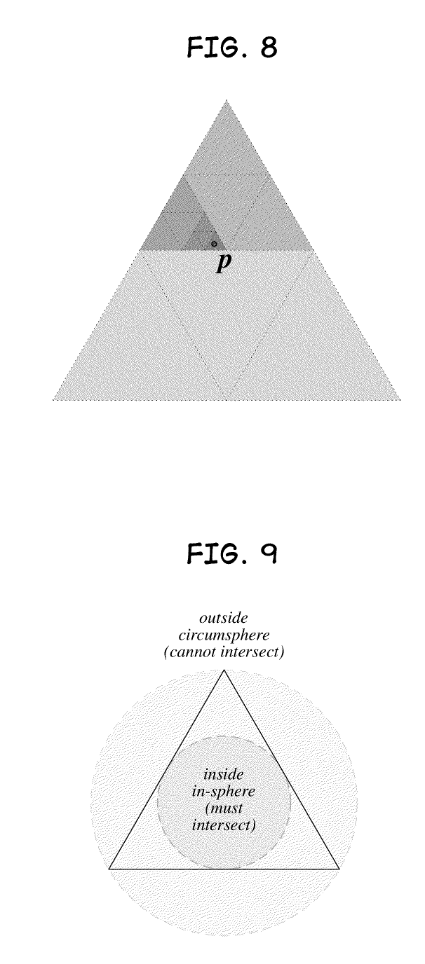

One such method is to compute intersection with all faces of the non subdivided solid. For any face that matches, compute the sub faces for the next subdivision and recurse, making sure to keep track of the subdivisions of interest. (See FIG. 8, code list. 3.)

Code listing 3:
pythonic pseudocode for a recursive intersection/subdivision algorithm

```
def intersect(a_pt_vec, a_check_faces, a_subdivisions):
    if a_subdivisions < 0:
        return [ ]
    intersecting_faces = [ ]
    for face in a_check_faces:
        if intersects(face, a_pt_vec):
            intersecting_faces.append(face)
    home_vertices = set(chain(*intersecting_faces))
    if a_subdivisions == 0:
        return [ home_vertices ]
    subdivided_faces = [ ]
    for face in intersecting_faces:
        midpoints = [
            midpoint(face[0], face[1]),
            midpoint(face[1], face[2]),
            midpoint(face[2], face[0])
        ]
        new_subdivided_faces = [
            [ face[0], midpoints[0], midpoints[2] ],
            [ face[1], midpoints[1], midpoints[0] ],
            [ face[2], midpoints[2], midpoints[1] ],
            midpoints
        ]
        subdivided_faces.extend(new_subdivided_faces)
    intersecting_sub_faces = \
        intersect(a_pt_vec, subdivided_faces, a_subdivisions − 1)
    return [ home_vertices ] + intersecting_sub_faces
```

This method of subdivision simply bisects each edge of each intersecting triangle and uses the vertices and bisection points to form four coplanar sub faces. No great circles are computed or used since they are unnecessary.

There are a few optimizations which could be made to the above algorithm. For example, if one were using the signed volume method of intersection detection, one could assume planar breach for all subsequent levels of recursion. Also, if one used a Platonic solid as the model, one could compute the dot product of the normalized point of interest norm(p) with the normal vectors of the faces of the solid. This could quickly rule in or out those faces where the point of interest was within the insphere or outside the circumsphere, respectively.

Most graphics applications requiring intersection detection do not need the actual point of intersection. For boolean detection, the signed volume method outperforms methods which compute that point. However, in our case, it is useful to know the point of intersection since it can lead to further optimization.

### Subdivision without Recursion Using Quantized Barycentric Triangulation

One method that calculates the point of intersection is barycentric intersection.⁷ This approach is compelling because barycentric coordinates allow for significant optimizations. However, their use is much more efficient when each face on the model solid is guaranteed to be convex. This is why the icosahedron and pentakis dodecahedron are preferable since triangles are always convex, and subdivisions are easily calculated. 7Möller, Thomas, and Ben Trumbore, “Fast, Minimum Storage Ray-Triangle Intersection.” Journal of Graphics Tools 2.1 (1997): 21-28, Print.

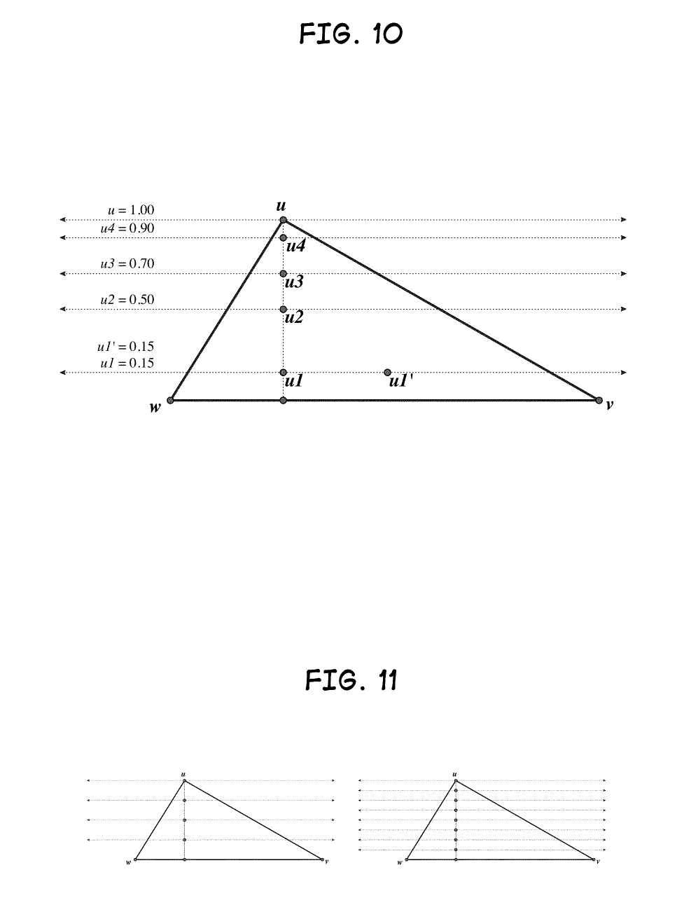

A review of barycentric coordinates is useful. While not often described this way, a triangular barycentric coordinate for a given vertex may be thought of as a normalized “altitude” above that vertex's opposing edge where 0% describes a line colinear with the opposing edge, and 100% describes a line parallel to the opposing edge which intersects the vertex. (See FIG. 10.)

For arbitrary subdivisions, one merely needs to determine the nearest quantized altitude for a given point. (See FIG. 11.)

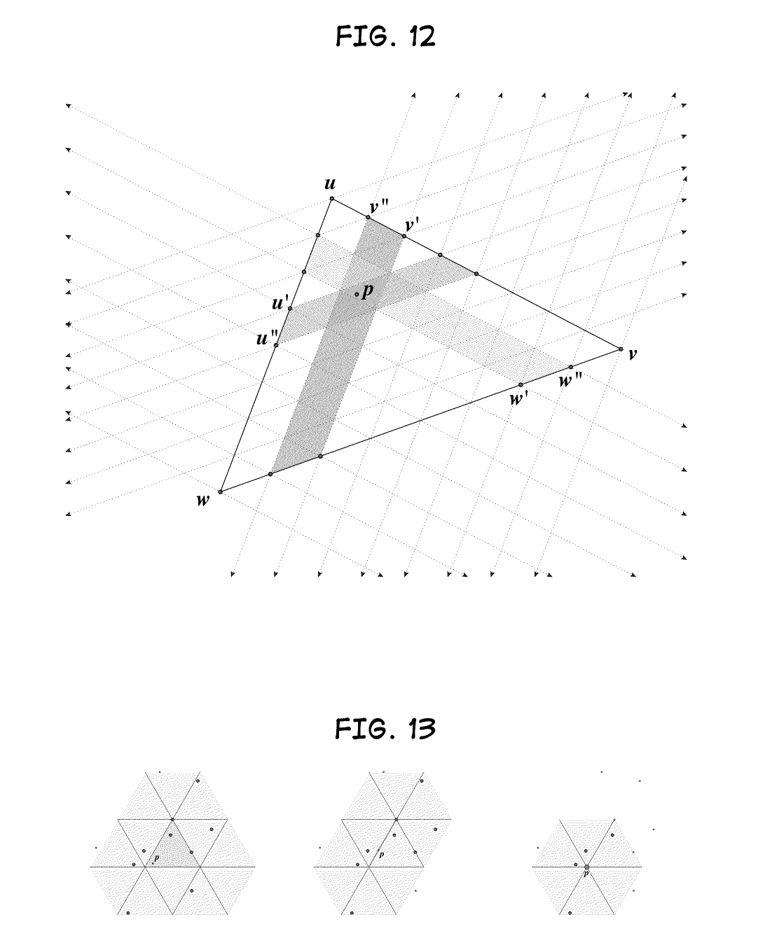

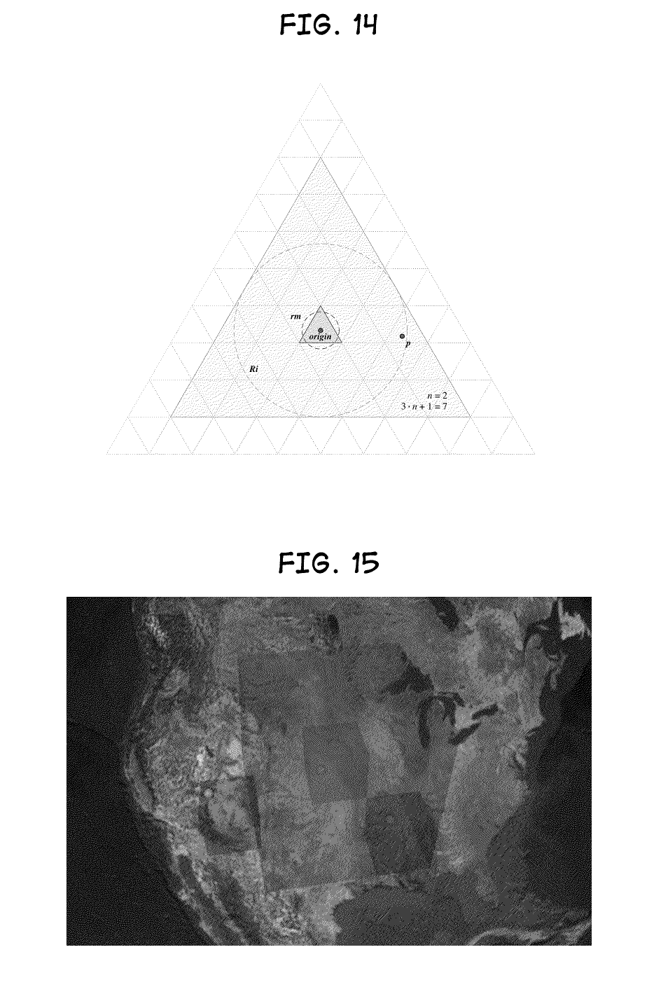

This conceptualization is exciting. Performing similar computations on all barycentric coordinates (“quantized barycentric triangulation”) allows us to quickly find the intersecting triangle for an arbitrary subdivision. (See FIG. 12, code list. 4.)

Code listing 4: pythonic pseudocode
for a quantized barycentric triangulation algorithm

```
def quantizehalves(a_v, a_x):
    “““
    >>> quantizehalves(0.25, 0)
    [0.0, 1.0]
    >>> quantizehalves(0.25, 1)
    [0.0, 0.5]
    >>> quantizehalves(0.25, 2)
    [0.0, 0.25, 0.5]
    >>> quantizehalves(0.25, 3)
    [0.125, 0.25, 0.375]
    ”””
    quantization = 2 ** a_x
    scaled = a_v * quantization
    quantized = int(scaled)
    # If we're on an edge or point, this is going to be the case
    # for at least one of our barycentric coordinates
    if scaled % quantization == quantized % quantization:
        return [ (quantized − 1) / quantization, \
            quantized / quantization, \
            (quantized + 1) / quantization ]
    if a_v < 0:
        return [ (quantized − 1) / quantization, \
            quantized / quantization ]
    # a_v >= 0
    return [ quantized / quantization, \
            (quantized + 1) / quantization ]
def intersect(a_pt_vec, a_model_faces, \
        a_subdivisions_of_interest):
    home_vertices = { }
    for subdv in a_subdivisions_of_interest:
        home_vertices[subdv] = set( )
    candidates = [ ]
    for face in a_model_faces:
        # bcInt( ) implements Moller's barycentric intersection
        # algorithm and returns [ u, v, w ] if the point
        # intersects and None if it doesn't
        bc_coords = bcInt(a_pt_vec, face[0], face[1], face[2])
        if bc_coords is not None:
            candidates.append(( bc_coords, face ))
    for bc_coords, face in candidates:
        u, v, w = bc_coords
        for subdv in a_subdivisions_of_interest:
            uq = quantizehalves(u, subdv)
            vq = quantizehalves(v, subdv)
            wq = quantizehalves(w, subdv)
            # product( ) creates the cartesian product of its
            # arguments; see
            # <http://tinyurl.com/65q4nl#itertools.product>
            candidates = set(product(uq, vq, wq))
            # Refine the triangulation to the border vertices
            # (barycentric coordinates must add up to 1); in most
            # cases, the above call to product( ) will yield 8
            # candidates, and this will weed out all but 3
            valid_uvw = \
                [ uvw for uvw in candidates if sum(uvw) == 1 ]
            for uvw in valid_uvw:
                # bc2Cart( ) takes a polygon and a barycentric
                # coordinate and returns the corresponding
                # cartesian coordinate
                home_vertices[subdv]. \
                    add(bc2Cart(face, uvw))
    return home_vertices
```

Initial experimentation suggests that this approach is over two-and-a-half times faster than the subdivision method outlined in code listing 3 for calculating subdivisions of the 6th, 10th and 13th degrees.

There is another optimization to be had for this method. Up until now, if a point has fallen on an edge or vertex, all the faces which share that edge or vertex become the point's home faces. For such a point, this approach expands the area of nearness (sometimes quite significantly in the case of a point on a vertex).

There are several alternatives. First, we could declare exactly one of the faces that has that edge or vertex as the point's home face. This would probably provide the most consistency (since all points would have exactly one home face). Alternatively, we could enforce that a point could have only a home face, home edge or single home vertex. If a point intersected a subdivision vertex, its home vertex for that subdivision would be that point (and only that point). If it intersected an edge, its home vertices would be that edge's endpoints. Otherwise, it would have one home face, and have that face's vertices as its home vertices.

This has some differences compared with the above implementation. First, points on the far edges of neighboring faces are no longer considered near. If a point has a home edge, only points intersecting faces which share that edge are included. If a point has a single home vertex, only points intersecting faces which share that point are included. (See FIG. 13.)

This has some advantages. First, if we consider the inradius of the smallest area of nearness (i.e., where a point of interest intersects a subdivision vertex) as the minimum radius of interest, and choose our subdivision accordingly, we will never exclude points outside of that radius as non near no matter where our point of interest falls. If the point of interest falls along an edge or within a face, then our nearness computation may be over-inclusive, but we can probably efficiently exclude those points after retrieval if necessary. Second, it makes our face intersection and barycentric calculations more efficient, since we can exclude redundancies. (See code list. 5.)

Code listing 5: pythonic pseudocode implementing the edge-vertex
optimization (changes from code list. 4 have been underlined)

```
def quantizehalves(a_v, a_x):
    “““
    >>> quantizehalves(0.25, 0)
    [0.0, 1.0]
    >>> quantizehalves(0.25, 1)
    [0.0, 0.5]
    >>> quantizehalves(0.25, 2)
    [0.25]
    >>> quantizehalves(0.25, 3)
    [0.25]
    ”””
    quantization = 2 ** a_x
    scaled = a_v * quantization
    quantized = int(scaled)
    if scaled % quantization == quantized % quantization:
        return [ quantized / quantization ]
    if a_v < 0:
        return [ (quantized − 1) / quantization, \
            quantized / quantization ]
    # a_v >= 0
    return [ quantized / quantization, \
            (quantized + 1) / quantization ]
def intersect(a_pt_vec, a_model_faces, \
        a_subdivisions_of_interest):
    home_vertices = { }
    for subdv in a_subdivisions_of_interest:
        home_vertices[subdv] = set( )
    for face in a_model_faces:
        bc_coords = bcInt(a_pt_vec, face[0], face[1], face[2])
        if bc_coords is not None:
            break
    # Get rid of the loop since we're only interested in at-most
    # one face (or its edges or vertices)
    if bc_coords is not None:
        u, v, w = bc_coords
        for subdv in a_subdivisions_of_interest:
            uq = quantizehalves(u, subdv)
            vq = quantizehalves(v, subdv)
            wq = quantizehalves(w, subdv)
            candidates = product(uq, vq, wq)
            valid_uvw = \
                [ uvw for uvw in candidates if sum(uvw) == 1 ]
            for uvw in valid_uvw:
                home_vertices[subdv]. \
                    add(bc2Cart(face, uvw))
    return home_vertices
```

Experimentation suggests that this simple enhancement is over three times faster than the previous version in code listing 4. This performance improvement brings it into the realm of practical utility for most web applications. Implementations in Java or C would likely see additional performance gains.

### Addressing Arbitrary Volumetric Nearness

### Tetrahedral Quantized Barycentric Triangulation

The above technique uses 2-space projections for approximating nearness on a presumed flat surface of a planetary body. But what about volumetric nearness? It turns out that the same technique can apply to 3-space as well, and in some ways is even simpler. It entails defining an origin in 3-space, defining or translating a point of interest using cartesian coordinates, defining a “unit” regular tetrahedron centered at the origin, scaling that unit tetrahedron by a quantized factor such that it is guaranteed to enclose the point of interest, then using the above barycentric triangulation method (modified for use in 3-space) to determine the point of interest's home volume.

For example, let's determine 3-space nearness on or around the surface of the earth using latitude/longitude/altitude triads. We place the origin at the center of the earth. We define the unit tetrahedron as one whose midradius rₘ is one half our desired precision p (e.g., a 50 km radius for a precision of 100 km). From this, we compute the edge length a of the unit tetrahedron. We then find the smallest tetrahedron whose edge length 3n+1 is a specific multiple of our unit tetrahedron edge length and whose inradius Rᵢ is greater than or equal to the distance between the origin and the point of interest rₚ. (See eq. 6.)

### Equation 6: Measurements Corresponding to a Tetrahedron-Based Model

$$\begin{matrix}{r}_{m} & = & \frac{\sqrt{2}}{4} a \\ & = & \frac{1}{2} p \\ a & = & \sqrt{2} p \\ {R}_{i} & = & \frac{\sqrt{6}}{12} ( 3 n + 1 ) a \\ \frac{\sqrt{3} n + \sqrt{3}}{2} p & \geq & {r}_{p} \\ 3 n + 1 & \geq & \frac{2 \sqrt{3}}{3 p} {r}_{p} \\ n & \geq & \frac{2 \sqrt{3}}{3 p} {r}_{p} - 1 \\ n & ε & {IN}_{1}\end{matrix}$$

Then we translate the point of interest into barycentric coordinates for the enclosing tetrahedron and perform an n-quantized 3-space barycentric triangulation similar to the 2-space version above. (See code list. 6.)

Code listing 6: pythonic pseudocode implementing quantized 3-space
barycentric triangulation

```
def quantize(a_v, a_n):
    “““
    >>> quantize(0, 1)
    [0]
    >>> quantize(0.25, 1 / 2)
    [0.0, 0.5]
    >>> quantize(105, 50)
    [100, 150]
    >>> quantize(−105, 50)
    [−150, −100]
    ”””
    quantized = int(a_v / a_n)
    if a_v % a_n == 0:
        return [ quantized * a_n ]
    if a_v < 0:
        return [ (quantized − 1) * a_n, quantized * a_n ]
    # a_v >= 0
    return [ quantized * a_n, (quantized + 1) * a_n ]
sqrt2 = sqrt(2)
sqrt3 = sqrt(3)
def intersect3d(a_pt_alt, a_precision):
    home_vertices = set( )
    # Assume a_alt and a_precision are in meters
    r_pt = a_alt + 6371009 # Earth's mean radius
    unit_edge_len = sqrt2 * a_precision
    unit_scalar = unit_edge_len / (2 * sqrt2)
    unit_tetrahedron = (
        vec( 1, 1, 1) * unit_scalar,
        vec(−1, −1, 1) * unit_scalar,
        vec(−1, 1, −1) * unit_scalar,
        vec( 1, −1, −1) * unit_scalar,
    )
    outer_scalar = ceil(2 * sqrt3 * r_pt / a_precision)
    outer_tetrahedron = \
        [ pt * outer_scalar for pt in unit_tetrahedron ]
    bc_coords = bcInt3d(a_pt_vec, *outer_tetrahedron)
    bc_coords_q = \
        [ quantize(i, outer_scalar) for i in bc_coords ]
    candidates = product(*bc_coords_q)
    valid_bc = \
        [ bc for bc in candidates if sum(bc) == 1 ]
    for bc in valid_bc:
        home_vertices.add(bc3d2Cart(outer_tetrahedron, bc))
    return home_vertices
```

### Cubic Quantization: Fast & Useful for Both Volumetric and Surface Area Nearness

While perhaps interesting, tetrahedral quantized barycentric triangulation is mostly an academic exercise. The resulting shape that defines near points in that model is a truncated tetrahedron. A cube is better at approximating spheres, and quantization with cubes is trivial by comparison. (See code list. 7.)

Code listing 7: pythonic pseudocode implementing cubic quantization

```
def intersect3d(a_pt_vec, a_precision):
    home_vertices = set( )
    # The edge length of a cube who's midradius is ½ of the
    # target precision
    edge_len = sqrt(2) * a_precision / 2
    coord_q = [ quantize(i, edge_len) for i in a_pt_vec ]
    for coord in product(*coord_q):
        home_vertices.add(coord)
    return home_vertices
```

Practically speaking, cube-based quantization is a much more efficient and accurate method of generalized nearness approximation in 3-space. The origin may be chosen arbitrarily (e.g., the center of the Earth, the center of the Milky Way, the fire hydrant down the street, etc.), so long as the maximum distances measurements and quantization precisions are efficiently supported by the computation environment. It also has the side effect of being pretty good at approximating planetary surface nearness. (See FIG. 15.)

Initial experimentation suggests that if the edge length calculations are cached or computed in advance, this method is almost fifteen times faster than the quantized barycentric triangulation on a model solid surface method described above!

While, the accuracy of approximating near points on the earth surface is not quite as good as triangles on a plane, the performance gains are too great to ignore. Missed points may be minimized by choosing cube quanta that are over-inclusive and then discarding any points outside the desired radius post-retrieval.

### Cubic Quantization with Spheres of Influence

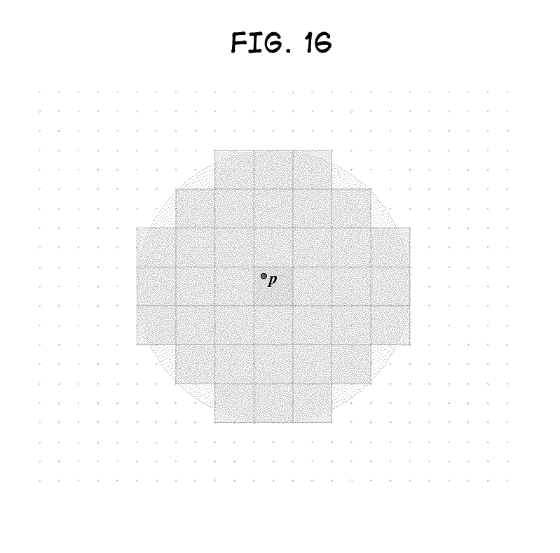

A final method uses cubic quantization to approximate nearness within a given precision (e.g., within 100 km±10 km). This involves four steps. The first step is to set the quantization to the precision (10 km in our example) and calculate and store the home cube for all points of significance Q. In this approach, the representation of each home cube is not its eight vertices, but rather its midpoint. The second step is to calculate the home cube for the point of interest p in the same way as the points of significance. The third step is to calculate the “sphere of influence” for that home cube with a radius equal to our desired nearness (100 km in our example). In reality, that sphere is a discrete set of points corresponding to the midpoints of all quantized cubes which fall inside of that sphere. (See FIG. 16.)

The fourth step is to compare the points inside the sphere of influence with the points of significance Q. Any of Q whose home cube midpoint corresponds with a point in the sphere of influence is considered near to the point of interest p.

Code listing 8: pythonic pseudocode implementing
cubic quantization with a sphere of influence
(significant changes from previous code listings have been underlined)

```
def quantize(a_v, a_n):
    “““
    >>> quantize(0, 1)
    [0, 1]
    >>> quantize(−10, 1)
    [−10, −9]
    >>> quantize(0.25, 1 / 2)
    [0.0, 0.5]
    >>> quantize(105, 50)
    [100, 150]
    >>> quantize(−105, 50)
    [−150, −100]
    ”””
    quantized = int(a_v / a_n)
    if a_v % a_n == 0:
        return [ quantized * a_n, (quantized + 1) * a_n ]
    if a_v < 0:
        return [ (quantized − 1) * a_n, quantized * a_n ]
    # a_v >= 0
    return [ quantized * a_n, (quantized + 1) * a_n ]
def distvec(a_p_vec, a_q_vec):
    diff_vec = a_p_vec − a_q_vec
    return sqrt(dot(diff_vec, diff_vec))
def calcHomeMdpt(a_pt_vec, a_precision):
    coord_q = [ quantize(i, a_precision) for i in a_pt_vec ]
    mdpt = [ (dim[1] − dim[0]) / 2 + dim[0] \
        for dim in coord_q ]
    mdpt_vec = vec(*mdpt)
    return mdpt_vec
def calcSphereOfInfluence(a_home_mdpt_vec, \
        a_precision, a_radius):
    # There are more efficient ways to do this, but this is easy
    # to follow; basically, we're checking all quantized points
    # within a cube whose edge length is a_radius and whose
    # midpoint is a_home_mdpt_vec and discarding those whose
    # distance to a_home_mdpt_vec is greater than a_radius
    sphere_pts = set( )
    quanta = a_radius // a_precision
    corner_vec = a_home_mdpt_vec − (quanta * a_precision)
    quanta_range = quanta * 2 + 1
    for x in range(quanta_range):
        for y in range(quanta_range):
            for z in range(quanta_range):
                candidate_vec = \
                    vec(corner_vec[0] + x * a_precision, \
                    corner_vec[1] + y * a_precision, \
                    corner_vec[2] + z * a_precision)
                if distvec(a_home_mdpt_vec, candidate_vec) \
                        <= a_radius:
                    sphere_pts.add(candidate_vec)
    return sphere_pts
def findNearPoints(a_pt_vec, a_precision, a_radius):
    home_mdpt_vec = calcHomeMdpt(a_pt_vec, a_precision)
    sphere_pts = calcSphereOfInfluence(home_mdpt_vec, \
        a_precision, a_radius)
    # Pseudo-GQL
    sphere_pts = mortonify(sphere_pts)
    query = db.Query(Points)
    query.filter(‘home_mdpt_%s IN’ % a_precision, sphere_pts)
    return query.fetch(...)
```

This approach is more complicated than basic cubic quantization. Because one would likely know the required precision(s) beforehand, one could optimize sphere of influence point calculations by computing an array of translations ahead of time (one for each point in the sphere) and then applying the translations to a point of interest's home midpoint to get the sphere of influence for that point. However, the smaller the ratio of the precision to the radius, the greater the number of points in the sphere of influence. For 50%, the sphere of influence contains 33 points. For 33%, it contains 123. For 10%, it contains 4,169. For 1%, it contains 4,187,857. This obviously isn't practical for most situations, and other methods are more efficient at achieving the same level of precision.

### CONCLUSION

Spherical coordinate systems (e.g., latitude/longitude, latitude/longitude/altitude) suffer from practical problems when computing nearness of points both on the surface of planetary bodies and more generally in 3-space. Searching for points of significance within arbitrary areas is feasible, but limits available storage mechanisms. For surface nearness, translating those points to quantized faces on a (subdivided) convex polyhedron solid addresses these shortcomings while providing enough precision to be practically useful. Barycentric triangulation allows for efficient quantization. For general 3-space applications, using quantized cubes is an efficient model. In any case, the resulting representations have practical uses for both storage and subsequent queries of near points in systems that limit inequality or range operations.

1-19. (canceled)

20. A method for storing geo-location data, including a set of n-space Cubic-Quantized home vertices of a point p; said point p being defined in a cartesian coordinate system; the method comprising the steps:
a. computing said set of n-space Cubic-Quantized home vertices from said point p;
b. creating a point record for storage in a non-transitory memory; and
c. associating said point p and the set of n-space Cubic-Quantized home vertices with said point record.

21. The method of claim 20 further comprising the step of encoding as a Morton number one of:
a. said point p; and
b. a member of said set of n-space Cubic-Quantized home vertices.

22. A method for retrieving geo-location data related to a set of n-space Cubic-Quantized home vertices of a point q; said point q being defined in a cartesian coordinate system; the method comprising:
a. computing said set of n-space Cubic-Quantized home vertices from said point q;
b. identifying point records in a non-transitory memory with which at least one member of said set of n-space Cubic-Quantized home vertices is associated.

23. The method of claim 22 further comprising the step of encoding as a Morton number one of:
a. said point q; and
b. a member of said set of n-space Cubic-Quantized home vertices.

24. A method for performing operations on n-space geo-location data in a normalized coordinate system, the method comprising the steps:
a. receiving one or both of:
i. a storage command comprising an input record; and
ii. a retrieval command comprising matching criteria;
b. upon receiving said storage command:
i. calculating from or identifying in said input record a point p;
ii. calculating from said point p or said input record, or identifying in said input record a set of home vertices P a set of home vertices P defining a shape that includes said point p;
iii. creating a point record in said non-transitory memory; and
iv. associating a member of said set of home vertices P with said point record;
c. upon receiving said retrieval command:
i. calculating from or identifying in said matching criteria a point q;
ii. calculating from said point q or said matching criteria, or identifying in said matching criteria a set of home vertices Q a set of home vertices Q defining a shape that includes said point q; and
iii. identifying in said non-transitory memory a point record associated with a member of said set of home vertices Q.

25. The method of claim 24, where:
a. said normalized coordinate system comprises a triangle ΔTₚ and a triangle ΔT_{q};
b. said point p or a projection of said point p is coplanar with and is included by said triangle ΔTₚ;
c. said set of home vertices P defines a sub-triangle ΔTₚ′, which is calculated by applying Quantized Barycentric Triangulation to said triangle ΔTₚ and said point p or said projection of said point p.
d. said point q or a projection of said point q is coplanar with and is included by said triangle ΔT_{q};
e. said set of home vertices Q defines a sub-triangle ΔT_{q}′, which is calculated by applying Quantized Barycentric Triangulation to said triangle ΔT_{q} and said point q or said projection of said point q.

26. The method of claim 24, where:
a. said normalized coordinate system comprises an n-dimensional cartesian coordinate system, n being a natural number greater than zero;
b. said set of home vertices P is calculated by applying n-space Cubic-Quantization to said point p; and
c. said set of home vertices Q is calculated by applying n-space Cubic-Quantization to said point q.

27. The method of claim 24, where the steps further comprise encoding as a Morton number one or more of:
a. said point p;
b. said point q;
c. said member of said set of home vertices P; and
d. said member of said set of home vertices Q.

28. The method of claim 24, where:
a. said input record comprises digital media or a reference to digital media;
b. said digital media comprise metadata; and
c. said point p is calculated from or identified in said metadata.

29. The method of claim 24, where:
a. said input record comprises a reference or pointer to data;
b. said input record does not comprise said data; and
c. said point p is calculated from or identified in said data.

30. The method of claim 29, where said reference to said data comprises a URL.

31. A system for storing geo-location data, including a set of n-space Cubic-Quantized home vertices of a point p; said point p being defined in a cartesian coordinate system; the system comprising:
a. a computer processor configured to compute said set of n-space Cubic-Quantized home vertices from said point p; and
b. a data store in electronic communication with said computer processor, said data store for:
i. creating a point record in a non-transitory memory; and
ii. associating said point p and said set of n-space Cubic-Quantized home vertices with said point record.

32. The system of claim 31, where the computer processor is further configured to encode as a Morton number one of:
a. said point p; and
b. a member of said set of n-space Cubic-Quantized home vertices.

33. A system for retrieving geo-location data related to a set of n-space Cubic-Quantized home vertices of a point q; said point q being defined in a cartesian coordinate system; the system comprising:
a. a computer processor configured to compute said set of n-space Cubic-Quantized home vertices from said point q; and
b. a data store in electronic communication with said computer processor, said data store for identifying point records in a non-transitory memory with which at least one member of said set of n-space Cubic-Quantized home vertices is associated.

34. The system of claim 33, where the computer processor is further configured to encode as a Morton number one of:
a. said point q; and
b. a member of said set of n-space Cubic-Quantized home vertices.

35. The system of claim 33, where the computer processor is further configured to encode a member of the set of n-space Cubic-Quantized home vertices as a Morton number.

36. A system for performing operations on n-space geo-location data in a normalized coordinate system, the system comprising:
a. a command input for receiving one or both of:
i. a storage command comprising an input record; and
ii. a retrieval command comprising matching criteria;
b. a non-transitory memory for storing or retrieving a point record;
c. a computer processor in electronic communication with said non-transitory memory and said command input, said computer processor configured to:
i. upon receiving said storage command:
A. calculate from or identify in said input record a point p;
B. calculate from said point p or said input record, or identify in said input record a set of home vertices P a set of home vertices P defining a shape that includes said point p;
C. create a point record in said non-transitory memory; and
D. associate a member of said set of home vertices P with said point record;
ii. upon receiving said retrieval command:
A. calculate from or identify in said matching criteria a point q;
B. calculate from said point q or said matching criteria, or identify in said matching criteria a set of home vertices Q a set of home vertices Q defining a shape that includes said point q; and
C. identify in said non-transitory memory a point record associated with a member of said set of home vertices Q.

37. The system of claim 36, where:
a. said normalized coordinate system comprises a triangle ΔTₚ and a triangle ΔT_{q};
b. said point p or a projection of said point p is coplanar with and is included by said triangle ΔTₚ;
c. said set of home vertices P defines a sub-triangle ΔTₚ′, which is calculated by applying Quantized Barycentric Triangulation to said triangle ΔTₚ and said point p or said projection of said point p.
d. said point q or a projection of said point q is coplanar with and is included by said triangle ΔT_{q};
e. said set of home vertices Q defines a sub-triangle ΔT_{q}′, which is calculated by applying Quantized Barycentric Triangulation to said triangle ΔT_{q} and said point q or said projection of said point q.

38. The system of claim 36, where:
a. said normalized coordinate system comprises an n-dimensional cartesian coordinate system, n being a natural number greater than zero;
b. said set of home vertices P is calculated by applying n-space Cubic-Quantization to said point p; and
c. said set of home vertices Q is calculated by applying n-space Cubic-Quantization to said point q.

39. The system of claim 36, where said computer processor is further configured to encode as a Morton number one or more of:
a. said point p;
b. said point q;
c. said member of said set of home vertices P; and
d. said member of said set of home vertices Q.

40. The system of claim 36, where:
a. said input record comprises digital media or a reference to digital media;
b. said digital media comprise metadata; and
c. said point p is calculated from or identified in said metadata.

41. The system of claim 36, where:
a. said input record comprises a reference or pointer to data;
b. said input record does not comprise said data; and
c. said point p is calculated from or identified in said data.

42. The system of claim 41, where said reference to said data comprises a URL.

43. Non-transitory computer-readable medium containing a program for causing a computer processor to perform Quantized Barycentric Triangulation of points a, b, c, and p; each of said points a, b, c, and p being defined in a cartesian coordinate system; and said points a, b, and c defining vertices of a triangle ΔT; the program comprising instructions for:
a. computing barycentric coordinate values u, v, and w for said point p in said triangle ΔT;
b. quantizing said barycentric coordinate value u to values u′, u″;
c. quantizing said barycentric coordinate value v to values v′, v″;
d. quantizing said barycentric coordinate value w to values w′, w″; and
e. determining which combinations of said values u′, u″, v′, v″, w′, and w″ define valid barycentric coordinates in said triangle ΔT.
